(19) United States
(12) Patent Application Publication
(10) Pub. No.: US 2009/0056440 A1
(43) Pub. Date: Mar. 5, 2009

(54) ADJUSTABLE MEASURING CUP

(76) Inventors: LYNN VENDL, Woodbridge, IL (US); Louis Henry, Scarsdale, NY (US); Melanie Conklin, Brooklyn, NY (US); Charles Paradise, New York, NY (US)

Correspondence Address: PATENT GROUP;C/O DLA PIPER US LLP, 203 N. LASALLE ST., SUITE 1900, CHICAGO, IL, 60601, US

(21) Appl. No.: 12/169,429

(22) Filed: Jul. 8, 2008

Related U.S. Application Data
(60) Provisional application No. 60/959,042, filed on Jul. 10, 2007.

(51) Int. Cl. G01F 19/00

(52) U.S. Cl. 73/429; 73/426

(57) ABSTRACT

Adjustable measuring cups include a housing having a peripheral wall having an open upper end, an outer surface, an inner surface, and a bottom surface. The adjustable measuring cups also include a platform slidably movable within the housing, and an adjustment wheel rotatably connected to the bottom surface of the housing. The platform has an upper surface and a lower surface. A plurality of connecting rods can be connected to the adjustment wheel, and can also be connected to the lower surface of the platform. The measuring volume of an adjustable measuring cup can be defined by the open upper end, the inner surface of the housing and the upper surface of the platform. The platform slidably moves when the adjustment wheel is rotated, thereby adjusting the measuring volume of the measuring cup.

### RELATED APPLICATIONS

This application claims the benefit of U.S. Provisional Patent Application Ser. No. 60/959,042, filed on Jul. 10, 2007, currently pending. The disclosure of which is hereby incorporated by reference in its entirety.

### BACKGROUND

This disclosure relates generally to a measuring cup, and more particularly to an adjustable measuring cup having a variable volume.

Measuring cups are generally used for cooking and baking to measure desired amounts ingredients. Measured ingredients are dispensed from the measuring cup for incorporation into the recipe being prepared. Ingredients measured with measuring cups can include, for example, liquid ingredients and dry ingredients. Liquid ingredients commonly include, but are not limited to, cooking oils, molasses, honey, water, milk, and fruit or vegetable juice. Dry ingredients commonly include, but are not limited to granular or powdered materials such as white sugar, brown sugar, flour, meals, and oats. Measuring cups tend to have a single measuring volume, and are often purchased in sets of cups having various measuring volumes.

### BRIEF SUMMARY

Measuring cups are described herein that are adjustable, providing a variable measuring volume.

Adjustable measuring cups are provided herein that include a housing having a peripheral wall and a bottom surface. The peripheral wall can have an open upper end, an outer surface, and an inner surface. The adjustable measuring cups also include a platform slidably movable within the housing, and an adjustment wheel rotatably connected to the bottom surface of the housing. The platform has an upper surface and a lower surface. A plurality of connecting rods can be connected to the adjustment wheel, and can also be connected to the lower surface of the platform. In some examples, the bottom surface of the housing includes a plurality of adjustment notches, and the adjustment wheel includes an adjustment tab that can be received by an adjustment notch on the bottom surface of the housing. The measuring volume of an adjustable measuring cup can be defined by the open upper end, the inner surface of the housing and the upper surface of the platform. The platform slidably moves when the adjustment wheel is rotated, thereby adjusting the measuring volume of the measuring cup.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 is a perspective view of an adjustable measuring cup with the platform in a raised position.

FIG. 2 is a cross section of the adjustable measuring cup of FIG. 1 with the platform in the lowered position.

FIG. 3 is a cross section of the adjustable measuring cup of FIG. 1 with the platform in an intermediate position.

FIG. 4 is a cross section of the adjustable measuring cup of FIG. 1 with the platform in the raised position.

FIG. 5 is a perspective view of the adjustable measuring cup of FIG. 1 with the platform removed.

FIG. 6 is a perspective view of an adjustment wheel for use in an adjustable measuring cup.

FIG. 7 is a top plan view of the adjustment wheel of FIG. 6.

FIG. 8 is a bottom plan view of the bottom surface of an adjustable measuring cup.

### DETAILED DESCRIPTION

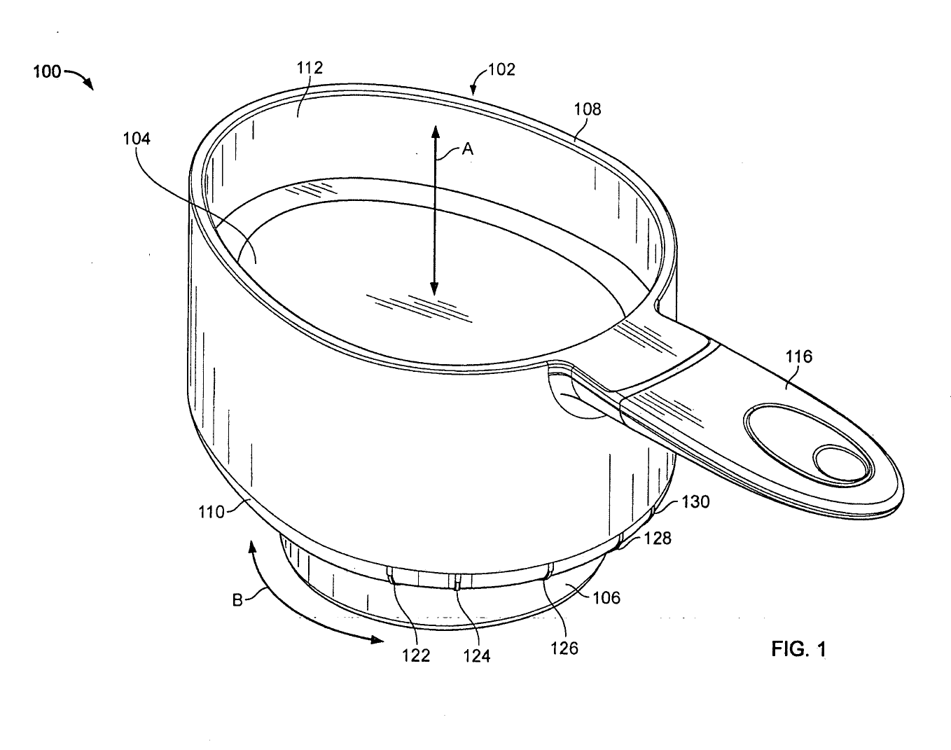

An adjustable measuring cup can be set to a desired measuring volume to measure and dispense various different volumes of ingredients. FIGS. 1-8 illustrate one example of an adjustable measuring cup 100, as well as various components thereof. Adjustable measuring cups, and the components thereof, can be made form any suitable material, including, but not limited to, plastic or metal, preferably food grade plastic or food grade metal.

FIG. 1 illustrates adjustable measuring cup 100. The adjustable measuring cup 100 has a housing 102, a platform 104 that is slidably movable within the housing 102, and an adjustment wheel 106 rotatably connected to the housing 102. The platform 104 slidably moves in a vertical direction, as indicated by arrow A, when the adjustment wheel 106 is rotated in a clockwise or counter clockwise direction, as indicated by arrow B, thereby adjusting the measuring volume of the adjustable measuring cup 100. The adjustable measuring cup 100 can preferably be used for measuring dry ingredients.

The housing 102 of adjustable measuring cup 100 includes a peripheral wall 108 and a bottom surface 110. The peripheral wall 108 includes an open upper end, an inner surface 112, and an outer surface 114. The adjustable measuring cup 100 can also have a handle 116 positioned on the outer surface 114 of the housing 102. The handle 116 can be integrally formed with the housing 102, or can be a separate piece that is attached to the housing 102. The handle can also be a single piece or multiple pieces. For example, as illustrated, handle 116 has a plastic core and a robber cover or coating that at least partially covers the plastic core.

As illustrated in FIGS. 1 through 4, platform 104 has an upper surface 118 and a lower surface 120. The platform 104 can have a size and shape that is substantially equal to the size and shape of the inner surface 112 of the housing. It is preferred that the platform 104, and the housing 102, have a shape that prevents rotation of the platform as the adjustment wheel is rotated to adjust the measurement volume of the adjustable measuring cup 100. Accordingly, the housing 102 and the platform 104 can be any suitable shape, but are preferably oblong, such as, for example, an oval or a rounded tear drop.

The platform 104 has a periphery around its edge. The upper surface 118 of the platform 104 can have a sealing element positioned at the periphery. For example, the sealing element can be attached to the upper surface 118 of the platform 104, and can contact the inner surface 112 of the housing 102 to prevent food materials from entering the adjustable measuring cup in any gap between the platform 104 and the housing 102. A sealing element can be any suitable material, including but not limited to, rubber or plastic.

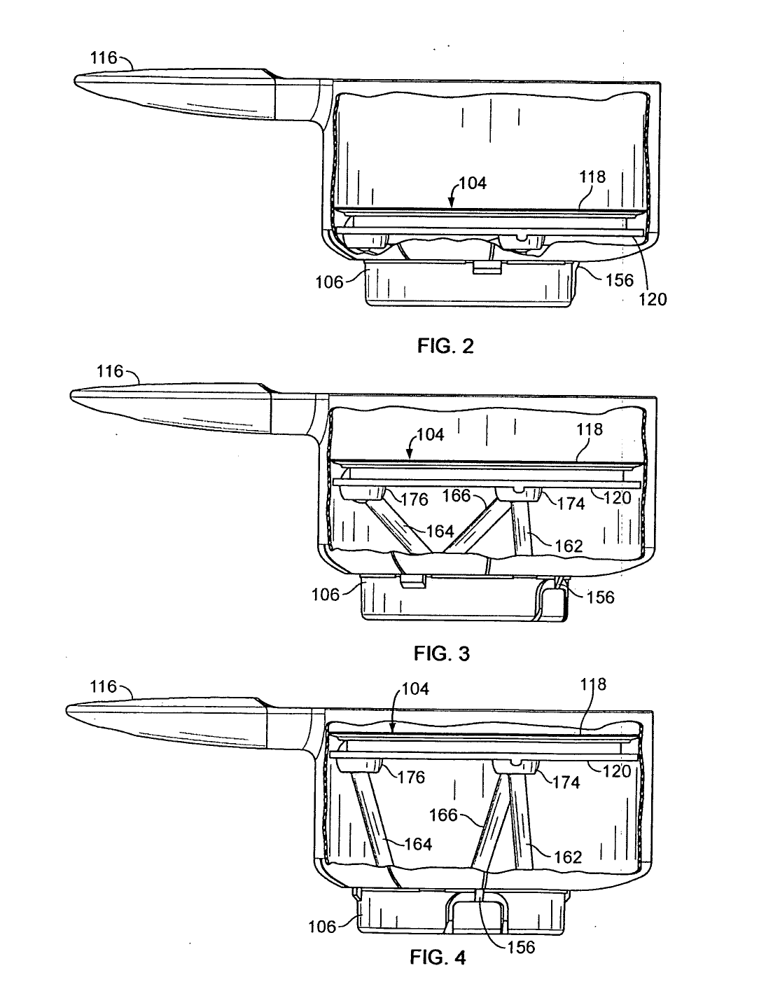

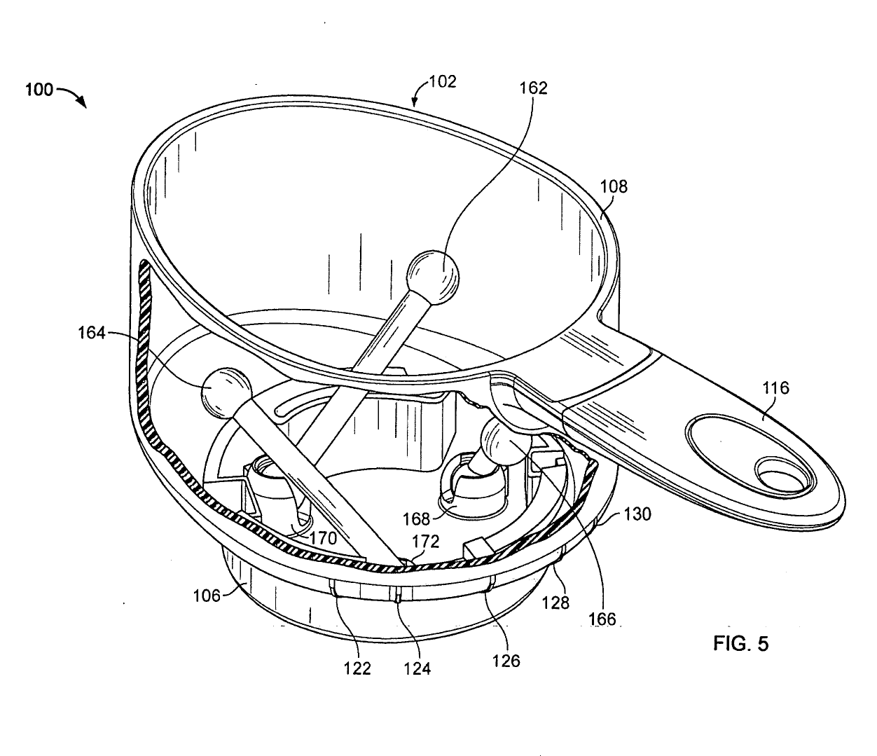

The measuring volume of the adjustable measuring cup can be defined by the open upper end, the inner surface 112 of the housing 102, and the upper surface 118 of the platform 104. As the platform 104 slidably moves up or down within the housing 102, the measuring volume is decreased or increased, respectively. Preferably, the platform 104 has a plurality of measurement positions, which each correspond to a predetermined measuring volume. The platform 104 can have at least two measurement positions, or more than two measurement positions, such as, for example, three measurement positions, four measurement positions, five measurement positions, six measurement positions, seven measurement positions, or more than seven measurement positions. For example, the platform 104 can have a lowered position, as illustrated in FIG. 2, and a raised position, as illustrated in FIG. 4. The lowered position of the platform can correspond to a first measuring volume, and the raised position of the platform can correspond to a second measuring volume. The platform can also have at least one intermediate position, as illustrated in FIG. 3 that can correspond to an intermediate measuring volume. Preferably, the platform 104 has a plurality of intermediate positions.

The predetermined measuring volumes that correspond to the measurement positions of the adjustable measuring cup 100 are preferably standard volumes for measuring ingredients, such as, for example, teaspoons, tablespoons, cups, milliliters, liters, ounces, fluid ounces, and fractions thereof. In instances where the predetermined measuring volumes are indicated in cups, suitable measurement volumes can include, but are not limited to eight cups, six cups, four cups, two cups, one cup, ¾ cup, ⅔ cup, ½ cup, ⅓ cup, ¼ cup, and ⅛ cup. As shown in FIG. 1, there can be indicia on the bottom surface 110 of the housing 102 that indicate the measurement position for each measuring volume, such as, for example, indicia 122, 124, 126, 128, 130, 132, 134 and 136. Alternatively, or in addition to the markings on the bottom surface 110 of the housing 102, there can be indicia on the outer surface 114 of the housing 102 that indicate measuring volumes to which the adjustable measuring cup can be set. For example, indicia on the outer surface 114 of the housing 102 can indicate at least the measuring volume when the platform 104 is in the lowered position and the measuring volume when the platform 104 is in the raised position. Preferably, the outer surface 114 of the housing 102 has indicia that indicate the location and value of each measurement volume. Indicia on the outer surface 114 of the housing 102 to indicate a measuring volume can correspond to the height of the upper surface 118 of the platform 104 at the measurement position for the desired measuring volume.

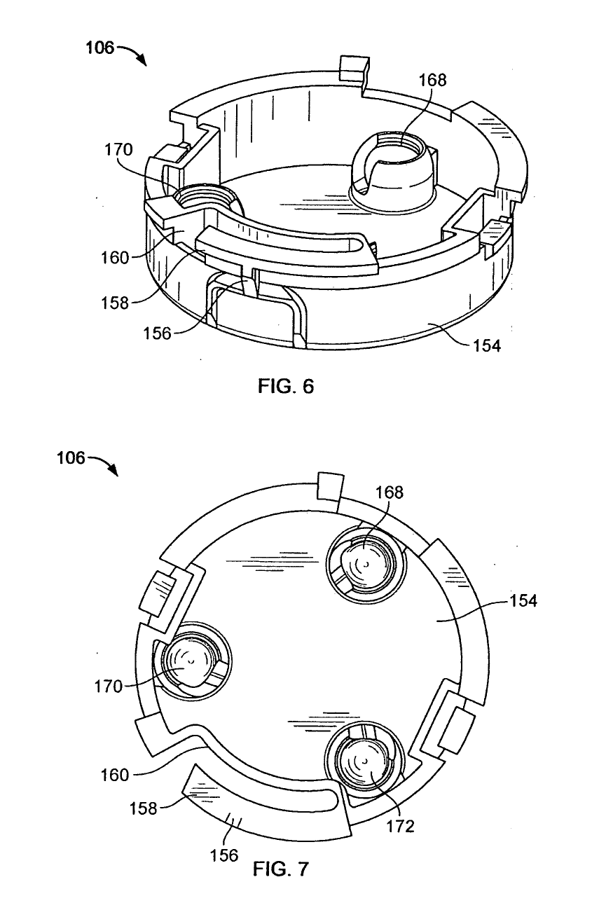

The adjustment wheel 106 can be rotatably connected to the adjustable measuring cup 100, and is preferably rotatably connected to the bottom surface 110 of the housing 102. The base 154 of the adjustment wheel 106 is preferably circular or substantially circular, to allow the adjustment wheel to rotate easily. Accordingly, the bottom surface 110 of the housing can have a circular or substantially circular opening therein that receives at least a portion of the adjustment wheel 106. The portion of the adjustment wheel that is not received by the bottom surface 110 of the housing 102 protrudes downwardly and can be gripped to rotate the adjustment wheel 106. The portion of the adjustment wheel that is not received by the bottom surface 110 of the housing 102 can have a cover or coating, such as a rubber coating or cover. As illustrated in FIGS. 6 and 7, an adjustment tab 156 can be positioned on the outer surface of the adjustment wheel. The adjustment wheel 106 is preferably configured so that the adjustment tab 156 can be pressed inwardly by manual force. In the example illustrated in FIGS. 6 and 7, the adjustment tab 156 is located on flex arm 158, which has one end that is spaced apart from the base 154 of the adjustment wheel 106 to form a flex space or groove 160.

As illustrated in FIGS. 2-5, a plurality of connecting rods can be connected to the adjustment wheel 106. The connecting rids can also be connected to the lower surface 120 of the platform 104. Adjustable measuring cup 100 can have two or more connecting rods, and preferably has three connecting rods 162, 164 and 166. Each connecting rod can have an elongate body, a first end, and a second end. Each connecting rod can be connected to the adjustment wheel 106 at the first end of the connecting rod in any suitable manner, and can also be connected to the lower surface 120 of the platform 104 at the second end of the connecting rod in any suitable manner. In the illustrated example, each connecting rod is connected to the adjustment wheel 106 by a ball and socket connection. Each connecting rod has a first ball at the first end of the connecting rod and a second ball at the second end of the connecting rod. The base 1154 of the adjustment wheel has sockets 168, 170, and 172, illustrated in FIG. 7, that each receives a ball on the first end of a connecting rod. Similarly, each connecting rod can also be connected to the lower surface 120 of the platform 104 by a ball and socket connection. For example, as illustrated in FIGS. 2 through 4, the lower surface 120 of the platform 104 can have sockets that each receive a ball on the second end of a connecting rod. FIGS. 2 through 4 show sockets 174 and 176 on the lower surface 120 of the platform 104, the third socket is not shown. In some examples, a ball on a connecting rod can be removed from and reinserted into a socket on the adjustment wheel 106 or the lower surface 120 of the platform 104. In other examples, a ball on a connecting rod can be retained in a socket on the adjustment wheel 106 or the lower surface 120 of the platform 104 in a permanent or non-removable manner.

In practice, when adjustment wheel 106 is rotated by the exertion of manual force, the first ends of the connecting rods 162, 164 and 166 also rotate due to the connection between the first ends of the connecting rods 162, 164 and 166 and the adjustment wheel 106. The platform 104 does not rotate because, for example, the shape of the platform 104 prevents it from rotating. When the second ends of the connecting rods 162, 164 and 166 are connected to the lower surface 120 of the platform 104, the second ends of the connecting rods 162, 164 and 166 cannot rotate. The connecting rods 162, 164 and 166 thus change their angle with respect to the base 154 of the adjustment wheel 106 as the adjustment wheel 106 is rotated. The second ends of the connecting rods 162, 164 and 166 raise or lower as the angle of the connecting rods 162, 164 and 166 increases or decreases, respectively. The platform 104 slidably moves in a vertical direction by an amount that corresponds to the change in height of the second ends of the connecting rods 162, 164 and 166.

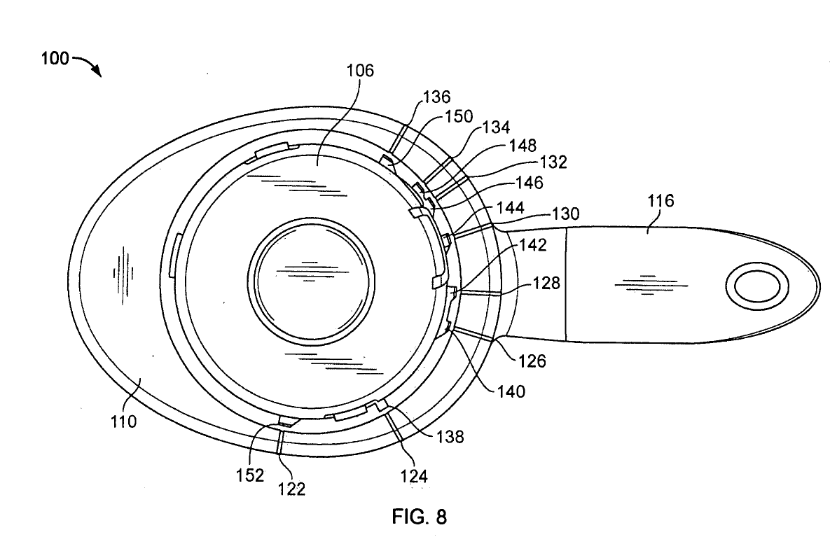

As illustrated in FIG. 8, the bottom surface 110 of the housing 102 can include a plurality of measurement notches, such as illustrated measurement notches 138, 140, 142, 144, 146, 148 and 150. Each measurement notch can correspond to a measurement position, and thus to a predetermined measuring volume. When the adjustment wheel 106 is rotated to set the platform to a desired measurement position, the adjustment tab 156 can be received by the corresponding measurement notch to lock the adjustment wheel 106 at the desired measuring position. In one example, the adjustment wheel 106 can be released for further adjustment of the measuring volume by pressing inwardly on the adjustment tab 156 until it is no longer retained in the measurement notch. The adjustment wheel 106 can then be rotated to a different measurement notch corresponding to a different measurement position. Alternatively, as shown at measurement notches 140-150 in FIG. 8, at least one, and preferably more than one, measurement notch can have at least one side that is substantially perpendicular to the adjustment wheel and at least one side that has an acute angle of inclination to the adjustment wheel. This configuration of the measurement notches facilitates rotation of the adjustment wheel 106 in the direction of the inclined side, and can allow the adjustment wheel to rotate in that direction without the need to physically press the adjustment tab 156, but impedes rotation of the adjustment wheel 106 in the opposite direction.

The bottom surface 110 of the housing 102 can also include a release notch 152 that corresponds to a release position. When the adjustment wheel 106 is rotated so that the adjustment tab 156 is received by the release notch 152, the adjustment wheel 106 can be removed from the housing 102, together with the connecting rods 162, 164 and 166, and the platform 104. Disassembling the adjustable measuring cup in this manner can facilitate cleaning.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. An adjustable measuring cup comprising:
a housing, the housing comprising a peripheral wall and a bottom surface, the peripheral wall having an open upper end, an outer surface, and an inner surface;
a platform slidably movable within the housing, the platform comprising an upper surface and a lower surface;
an adjustment wheel rotatably connected to the bottom surface of the housing;
a plurality of connecting rods connected to the adjustment wheel; and
a measuring volume defined by the open upper end, the inner surface of the housing and the upper surface of the platform;
wherein the platform slidably moves when the adjustment wheel is rotated, thereby adjusting the measuring volume of the measuring cup.

2. The adjustable measuring cup of claim 1, wherein the platform has a lowered position and a raised position.

3. The adjustable measuring cup of claim 2, wherein the platform further has at least one intermediate position.

4. The adjustable measuring cup of claim 3, wherein the platform further has a plurality of intermediate positions.

5. The adjustable measuring cup of claim 1, wherein the housing further comprises a handle positioned on the outer surface of the housing.

6. The adjustable measuring cup of claim 1, wherein each connecting rod is connected to the adjustment wheel by a ball and socket connection.

7. The adjustable measuring cup of claim 1, wherein each connecting rod is connected to the lower surface of the platform.

8. The adjustable measuring cup of claim 7, wherein each connecting rod is connected to the lower surface of the platform by a ball and socket connection

9. The adjustable measuring cup of claim 1, wherein each connecting rod comprises a first end having a first ball thereon and a second end having a second ball thereon.

10. The adjustable measuring cup of claim 1, wherein the housing further comprises indicia on the outer surface of the housing that indicate at least the measuring volume when the platform is in the lowered position and the measuring volume when the platform is in the raised position.

11. The adjustable measuring cup of claim 1, wherein the platform has a periphery, and the upper surface of the platform has a sealing element at the periphery.

12. The adjustable measuring cup of claim 1, wherein the adjustment wheel comprises an adjustment tab.

13. The adjustable measuring cup of claim 12, wherein the bottom surface of the housing comprises a plurality of measurement notches, each measurement notch corresponding to a predetermined measuring volume, and the adjustment tab is received by a measurement notch when the adjustment wheel is rotated to set the platform to the predetermined measuring volume.

14. The adjustable measuring cup of claim 13, wherein each measurement notch comprises at least one side that is substantially perpendicular to the adjustment wheel and at least one side that has an acute angle of inclination to the adjustment wheel.

15. The adjustable measuring cup of claim 13, wherein the bottom surface of the housing further comprises a release notch that corresponds to a release position, and the adjustment wheel, connecting rods, and platform can be removed from the housing when the adjustment tab is received by the release notch.

16. An adjustable measuring cup comprising:
a housing, the housing comprising a peripheral wall and a bottom surface having a plurality of adjustment notches, the peripheral wall having an open upper end, an outer surface, and an inner surface;
a platform slidably movable within the housing, the platform comprising an upper surface and a lower surface;
an adjustment wheel rotatably connected to the bottom surface of the housing, the adjustment wheel having an adjustment tab that can be received by an adjustment notch;
a plurality of connecting rods connected to the adjustment wheel; and
a measuring volume defined by the open upper end, the inner surface of the housing and the upper surface of the platform;
wherein the platform slidably moves when the adjustment wheel is rotated, thereby adjusting the measuring volume of the measuring cup.

17. The adjustable measuring cup of claim 16, wherein the platform has a lowered position corresponding to a first measuring volume, and a raised position corresponding to a second measuring volume.

18. The adjustable measuring cup of claim 17, wherein the platform further has at least one intermediate position corresponding to an intermediate measuring volume.

19. An adjustable measuring cup comprising:
a housing, the housing comprising a peripheral wall and a bottom surface having a plurality of adjustment notches, the peripheral wall having an open upper end, an outer surface, and an inner surface;
a platform slidably movable within the housing, the platform comprising an upper surface and a lower surface;
an adjustment wheel rotatably connected to the bottom surface of the housing, the adjustment wheel having an adjustment tab that can be received by an adjustment notch;
a plurality of connecting rods connected to the adjustment wheel and to the lower surface of the platform; and
a measuring volume defined by the open upper end, the inner surface of the housing and the upper surface of the platform;
wherein the platform slidably moves when the adjustment wheel is rotated, thereby adjusting the measuring volume of the measuring cup.

20. The adjustable measuring cup of claim 19, wherein each connecting rod is connected to the adjustment wheel by a ball and socket connection, each connecting rod is connected to the lower surface of the platform by a ball and socket connection.
